(19) United States
(12) Patent Application Publication
(10) Pub. No.: US 2023/0370361 A1
(43) Pub. Date: Nov. 16, 2023

(54) TRANSFER ROUTE CHANGE SYSTEM, PACKET PROCESSING APPARATUS, SUPERVISORY APPARATUS, TRANSFER ROUTE CHANGE METHOD AND PROGRAM

(71) Applicant: NIPPON TELEGRAPH AND TELEPHONE CORPORATION, Tokyo (JP)

(72) Inventors: Koji SUGISONO, Tokyo (JP); Shinya KAWANO, Tokyo (JP)

(21) Appl. No.: 18/246,547

(22) PCT Filed: Oct. 16, 2020
(86) PCT No.: PCT/JP2020/039121

§ 371 Date: Mar. 24, 2023

(51) Int. Cl. H04L 45/121; H04L 45/00

(52) U.S. Cl. CPC H04L 45/121; H04L 45/38

(57) ABSTRACT

In a transfer path change system for changing a transfer path of a flow in a network, a first packet processing device; a second packet processing device; and a supervision device for supervising migration processing of packet processing data used by the first packet processing device to the second packet processing device, are included. The second packet processing device receives the packet processing data; stores a packet arriving at the second packet processing device during transfer of the packet processing data; and processes the packet stored and transferring the processed packet to a destination. The supervision device instructs a third packet processing device, which performs transfer processing of the packet processing data next, to perform the transfer processing of the packet processing data with completion of the processing of a packet for a specific flow among packets of a plurality of flows stored as a trigger.

### TECHNICAL FIELD

The present invention relates to a technique of changing a flow path on a network.

### BACKGROUND ART

By a development of cloud computing, services requiring high-performance processing such as virtual reality, augmented reality, and online games can be easily delivered to customers. In particular, by offloading a processing of a mobile terminal which can only mount low calculation processing performance due to restriction of power and sales price to the cloud, these services can be enjoyed while moving.

In such services, since a behavior of user is displayed on a display of the terminal in a natural manner, it is required to shorten off-load data between the terminal and the cloud and transfer delay of a result, and to quicken the response to the behavior.

For this reason, attention is focused on mobile edge computing in which an offload device is installed in a cloud arranged near a base station of the mobile service and calculation processing offloaded from the terminal is executed.

In the mobile edge computing, since the number of base stations is very large, resources for calculation in the cloud such as a server and a network line are less than those in the conventional cloud in order to reduce costs for infrastructure investment and maintenance. On the other hand, the number of users accessing the service dynamically changes, and data communication occurs each time, so that a deviation occurs in a communication path, and as a result, the deviation occurs in resources in the cloud. This results in a difference in response between users and shortage of resources for setting a new user path. For this reason, it is required to equalize resources in the cloud by dynamically changing a flow path for improving convenience of service and the number of accommodated users.

In addition, in service operation, network functions (NF), such as a firewall, an intrusion detection system (IDS), etc. are introduced in order to improve convenience.

### CITATION LIST

### Non Patent Literature

[NPL 1] W. Cerroni and F. Callegati, “Live migration of virtual network functions in cloud-based edge networks”, in Proc. 2014 IEEE Int. Conf. Commun. (ICC 2014), Sydney, Australia, 2014, pp. 2963-2968
[NPL 2] K. Sugisono, A. Fukuoka, and H. Yamazaki, “Migration for VNF Instances Forming Service Chain”, in Proc. 2018 IEEE 7th Int. Conf. Cloud Netw. (CloudNet 2018), Tokyo, Japan, 2018, pp. 1-3

### SUMMARY OF INVENTION

### Technical Problem

The NF described above performs processing by using a state (may be called as data for packet processing) describing the latest information of the flow. When a part of information is missing, the network function does not operate well. For example, in a case of IDS, it is judged whether the flow is an attack flow to the system or a normal service flow based on the behavior of the flow so far. If some of the states are lost, the flow should be judged to be the attack flow, however is determined to be the normal service flow. Therefore, when dynamically rearranging the flow, the state of the network function which has processed the flow must be simultaneously migrated.

However, the conventional technique has a problem that the transfer delay of packets in the flow increases in the flow rearrangement. In the service requiring off-loading, when the delay increases in either one of two-way communication between the mobile terminal and the off-load device, the response of service deteriorates.

NPLs 1 and 2 describe a technique for suppressing an increase in delay during flow rearrangement in one-way communication. However, when the techniques disclosed in NPLs 1 and 2 are used, there is a demerit that the delay of packet of the reverse flow is greatly deteriorated when the delay of packet of the flow toward either direction is optimized.

The present invention has been made in view of the above-mentioned point, and it is an object of the present invention to provide a technique capable of suppressing an increase in transfer delay during flow rearrangement for packets directed in either direction in the rearrangement of the flow flowing through the network function.

### Solution to Problem

According to the disclosed technique, there is provided a transfer path change system for changing a transfer path of a flow in a network, the transfer path change system includes
a first packet processing device for processing and transferring a packet of the flow,
a second packet processing device installed in the transfer path after a change of the transfer path of the flow, and
a supervision device for supervising migration processing of packet processing data used by the first packet processing device to the second packet processing device, wherein
the second packet processing device includes
a packet processing data reception unit for receiving the packet processing data transferred from the first packet processing device,
a storage unit for storing a packet arriving at the second packet processing device during the transfer of the packet processing data, and
a packet processing transfer unit for processing the packet stored in the storage unit and transferring the packet to a destination,
after the transfer of the packet processing data is completed, and the supervision device includes
a migration management unit for instructing a third packet processing device, which performs transfer processing of the packet processing data next, to perform the transfer processing of the packet processing data with completion of the processing of a packet for a specific flow among packets of a plurality of flows stored in the storage unit in the second packet processing device as a trigger.

### Advantageous Effects of Invention

According to the disclosed technique, there is provided a technique capable of suppressing an increase in transfer delay during flow rearrangement for packets directed in either direction in the rearrangement of a flow flowing through a network function.

### BRIEF DESCRIPTION OF DRAWINGS

FIG. 1 is an overall configuration example of a system according to an embodiment of the present invention.

FIG. 2 is a diagram for explaining an example of flow migration.

FIG. 3 is a diagram for explaining a problem.

FIG. 4 is a diagram for explaining an overview of a state migration according to the embodiment of the present invention.

FIG. 4 is a diagram for explaining an overview of a state migration according to the embodiment of the present invention.

FIG. 6 is a diagram illustrating an example of a network configuration in an embodiment of the present invention.

FIG. 7 is a functional configuration diagram of state migration supervision device.

FIG. 8 is a functional configuration diagram of a packet transfer device.

FIG. 9 is a diagram showing a hardware configuration example.

FIG. 10 is a diagram showing an operation example of a flow migration.

FIG. 11 is a flowchart showing overall processing operations.

FIG. 12 is a diagram for explaining a traffic amount measurement in each flow direction.

FIG. 13 is a flowchart showing a procedure of a migration order determination method.

FIG. 14 is a diagram for explaining the migration order determination method.

FIG. 15 is a flowchart for explaining the procedure of the state migration.

FIG. 16 is a diagram showing an example of a path to be set in advance.

FIG. 17 is a diagram for explaining the procedure of the state migration.

FIG. 17 is a diagram for explaining the procedure of the state migration.

FIG. 17 is a diagram for explaining the procedure of the state migration.

### DESCRIPTION OF EMBODIMENTS

Hereinafter, an embodiment of the present invention (the present embodiment) will be described with reference to drawings. The embodiment to be described below is merely exemplary and embodiments to which the present invention is applied are not limited to the following embodiment. For example, in the following embodiments, a flow to be processed and transferred by a network function is shown in two directions as an example, but the two directions is only example, the flow in three or more directions may be handled.

### Overall Configuration Example of System

In the present embodiment, a system in which interactive services requiring high-performance processing such as virtual reality, augmented reality, and online games can be easily enjoyed while moving by offloading the processing of the mobile terminal to the cloud is assumed.

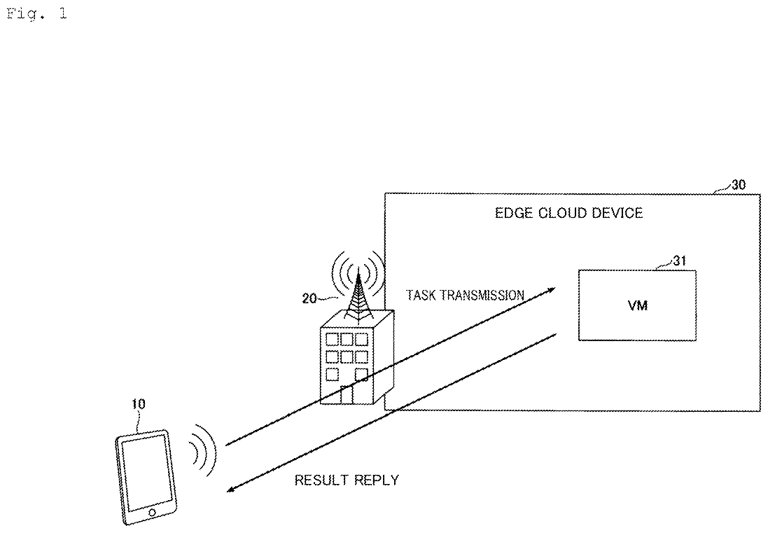

FIG. 1 shows an overall configuration example of a system according to an embodiment of the present invention. As shown in FIG. 1, the system includes a mobile terminal 10, a base station 20 for mobile service, and an edge cloud device 30.

The edge cloud device 30 is a device for an offload of a cloud arranged near the base station 20, and executes calculation processing offloaded from the terminal 10. More specifically, for example, a VM (virtual machine) 31 in the edge cloud device 30 executes the calculation processing of a task requested from the mobile terminal 10. That is, two-way communication of task transmission and result reply is performed.

As described above, in a mobile edge computing, since the number of base stations is very large, in order to reduce costs for infrastructure investment and maintenance, resources for calculation in the cloud such as a server and a network line are less than those in the conventional cloud. On the other hand, the number of users accessing the service dynamically changes, and data communication occurs each time, so that a deviation occurs in a communication path, and as a result, the deviation occurs in resources in the cloud. This results in a difference in response between users and shortage of resources for setting a new user path. For this reason, it is required to equalize resources in the cloud by dynamically changing a flow path for improving convenience of service and the number of accommodated users.

In addition, during service operation, network functions (NF) such as a firewall, an intrusion detection system (IDS), etc. are introduced for convenience improvement. As described above, such NF performs processing using a state in which the latest information of the flow is described. When a part of information is missing, the network function does not operate well. For example, in a case of IDS, it is judged whether the flow is an attack flow to the system or a normal service flow based on the behavior of the flow so far. If some of the states are lost, the flow should be judged to be the attack flow, however is determined to be the normal service flow. Therefore, when dynamically rearranging the flow, the state of the network function which has processed the flow must be simultaneously migrated.

In the present embodiment, a network function requiring the above-mentioned state for its operation is assumed as the network function. Such the network function is called a state-full network function.

### (About the Problem)

When the flow passes through the network function during the state migration, since the network function cannot perform processing to the flow until the state is updated, the network function stores the arrival packet belonging to the flow in a queue until the state is updated. Therefore, the transfer delay of the packet flowing in the flow increases in the flow rearrangement.

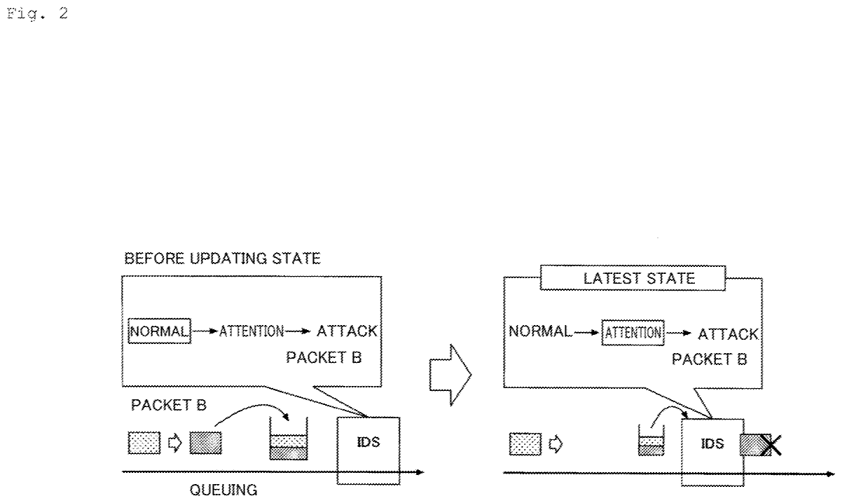

An example will be described with reference to FIG. 2. FIG. 2 shows the migration of the state in the rearrangement of the flow in the case where the IDS is used as the network function. As shown in the left side of FIG. 2, before the state is updated, since there is no state in which the sign of the attack is recorded, the packet is queued without restarting the processing. After that, when the migration of the state is completed, the processing is restarted as shown on the right side of FIG. 2, for example, it can be detected that the packet B is an attack packet.

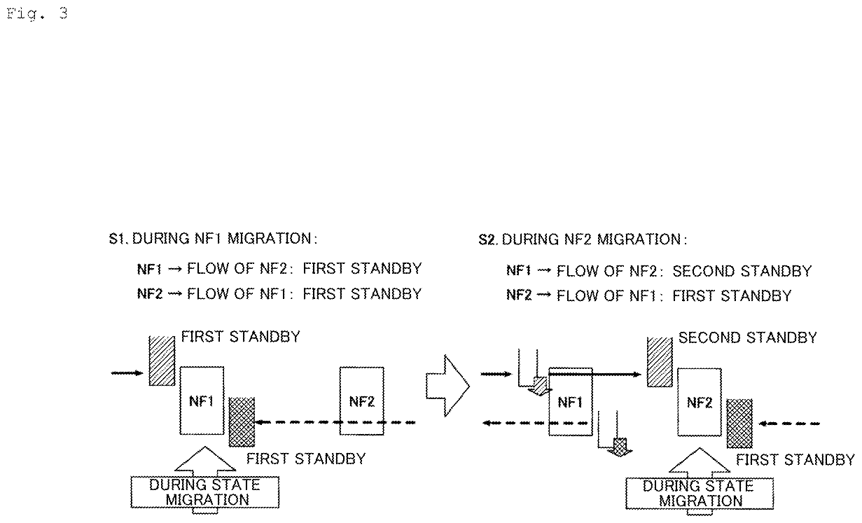

As described above, the network function stores the arriving packets belonging to the flow in the queue until the state is updated, and at this time, the queuing delay that each packet suffers changes in accordance with the state migration timing of the network function and the packet traveling direction. This will be described by using an example with reference to FIG. 3.

Two network functions exist between the mobile terminal and the off-load device, and are defined as NF1 and NF2, respectively. In the NF1 and the NF2, a situation is considered in which start timing of state migration is sequential and continuous. Immediately after the state migration of the NF1 is completed, the state migration of the NF2 is performed.

As shown in S1 in FIG. 3, during the state migration of the NF1, respective packets from the NF1 to the NF2 and from the NF2 to the NF1 are queued at the NF1. As shown in S2, after the state migration of the NF1 is completed, the former packet is directed to the NF2 and the latter packet is directed to the mobile terminal. Since the NF2 starts the state migration immediately after completion of the state migration of the NF1, the former packet is queued again immediately after arriving at the NF2.

As shown in FIG. 3, in the migration of states of NF1 and NF2, the number of times of waiting for the flow from NF2 to NF1 is one, whereas the number of times of waiting for the flow from NF1 to NF2 is two.

In this way, when the start timing of the state migration in the plurality of NFs is made to be sequential and continuous, the number of waiting times that the packet suffers, that is, the waiting time, varies depending on the direction. Therefore, the delay is greatly extended depending on the direction of flow progress direction and the schedule of migration.

This migration method is used when the state migration of all NFs is completed earlier and each NF packet processing resource used before the migration is desired to be released earlier. Further, the number of times that packets of the flow from the NF2 to the NF1 are queued is suppressed to one at the maximum by continuously migration. There is a migration method in which states of the NF1 and the NF2 are simultaneously performed in parallel, but in this system, queuing time is prolonged in both directional flows.

In the service requiring off-loading, when the delay increases in either one of two-way communication between the mobile terminal and the off-load device, the response of service deteriorates. A technique according to the present embodiment, which solves this problem and can suppress an increase in transfer delay during flow rearrangement for packets directed in either direction, will be described below.

### Overview of Embodiment

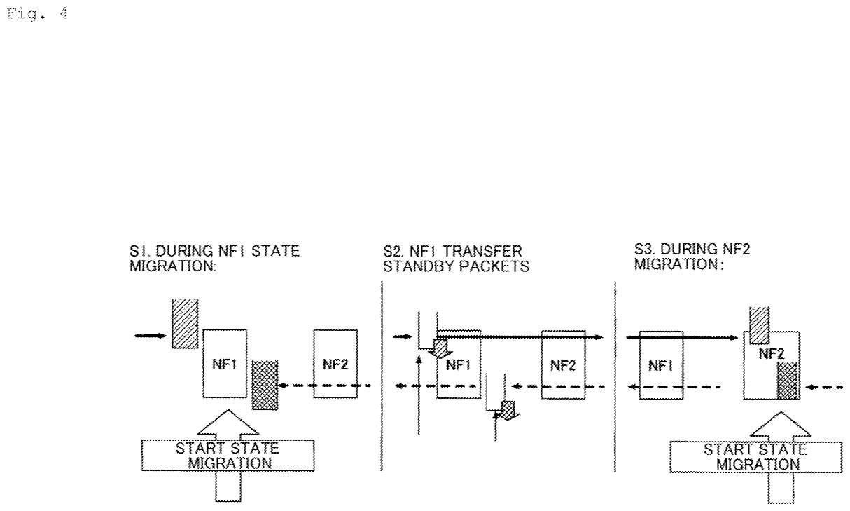

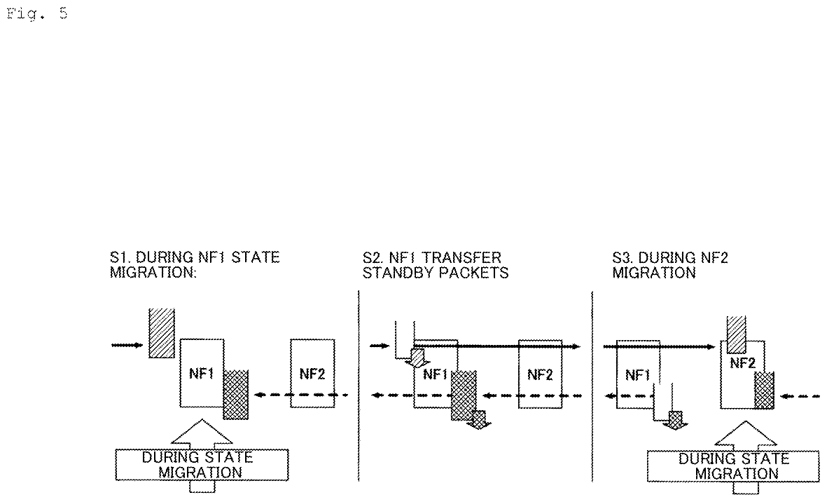

An overview of the present embodiment will be described with reference to FIGS. 4 and 5. In FIGS. 4 and 5, as in FIG. 3, there are two network functions between the mobile terminal and the off-load device, respectively, NF1 and NF2, it is assumed that the state migration of the NF2 is performed immediately after the state migration of the NF1 is completed.

In the present embodiment, the state migration of the next NF is executed after the transfer of the waiting packet is completed, so that the number of waiting times of the packet is set to 1 at the maximum. That is, in S1 of FIG. 4, during the state migration in the NF1 after the state migration is started, the packets from the NF1 to the NF2 are queued in the NF1 of the state migration destination, and the packets from the NF2 to the NF1 are queued at the same time.

When the migration of the state in the NF1 is completed in S2, the packets waiting by queuing are transmitted from the NF1. When one of two queues in the NF1 becomes empty, the state migration of the NF2 is executed in S3.

FIG. 5 is a diagram showing the operation of state migration in the NF1 and the NF2 shown in FIG. 4 in more detail.

In this embodiment, attention is focused on the flow in which the queue can be emptied first of two unidirectional flows. In the example shown in FIG. 5, the flow from the NF1 to the NF2 is the flow allowing the queue to be emptied first among the flow from NF1 to NF2 and the flow from NF2 to NF1.

As shown in S1 in FIG. 5, in the state of the NF1 during the state migration, each packet is queued in the NF1 in both directions.

When the state migration of the NF1 is completed, the packets are transmitted from each queue of the bidirectional flow in S2. The queue corresponding to the flow from the NF1 to the NF2 becomes empty first, and the state migration of the NF2 being the next NF is started by using it as a trigger.

Further, in the present embodiment, the state migration order is determined so that the NF for the state migration does not exist in the progress direction of the packet with respect to the NF with the queue in the flow in the direction opposite to the flow in which the queue can be made empty quickly.

By such processing, the next state migration can be started quickly, and the resources for NF operating in an old place can be released early. Hereinafter, the configuration and operation according to the present embodiment will be described in detail.

### Detailed Configuration Example of the System

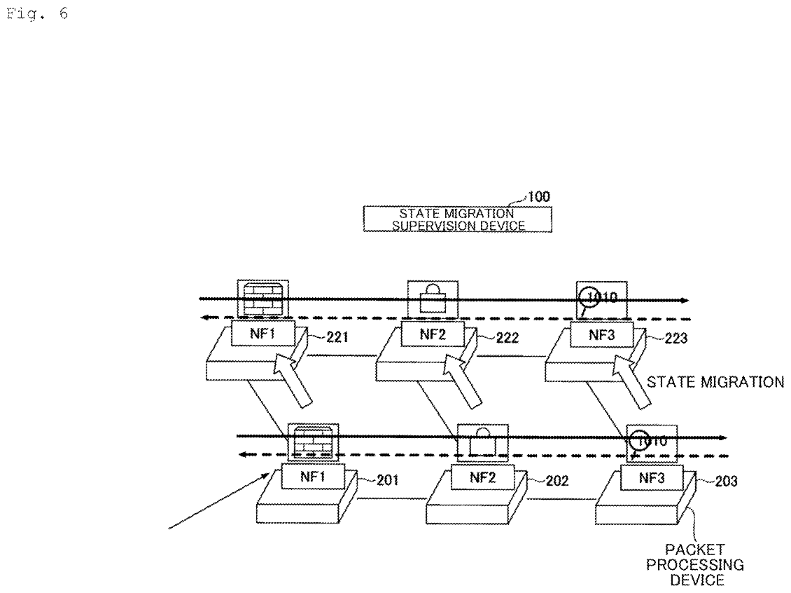

FIG. 6 shows an example of a detailed configuration of a system according to the present embodiment. As shown in FIG. 6, the present system includes a state migration supervision device 100, and a plurality of packet processing devices 201 to 203, 221 to 223. Each packet processing device can communicate with each other through a transmission line. Further, the state migration supervision device 100 and each packet processing device can communicate with each other through, for example, a control line.

A bidirectional flow between the mobile terminal 10 and the task processing device 11 flows through the packet processing device 201 to 203. Here, it is assumed that the task processing of the mobile terminal 10 is migrated from the task processing device 11 to the task processing device 12, and in the migration, the bidirectional flow which flows through the packet processing device 201 to 203 is rearranged to the packet processing device 221 to 223.

The packet processing devices 201 and 221 include the NF1 as the network function, the packet processing devices 202 and 222 include the NF2 as the network function, and the packet processing devices 203 and 223 include the NF3 as the network function. The NF1, NF2, and NF3 are firewall, IDS, or the like, and any of them may operate as a virtual machine on the packet processing device or may be implemented in hardware in the packet processing device. Note that the network function may be referred to as the packet processing device.

When the flow is rearranged, the state of the NF1 is transferred from the packet processing device 201 to the packet processing device 221, the state of the NF2 is transferred from the packet processing device 202 to the packet processing device 222, and the state of the NF3 is transferred from the packet processing device 203 to the packet processing device 223.

The state migration supervision device 100 supervises and manages the state migration as described above.

### (Device Configuration)

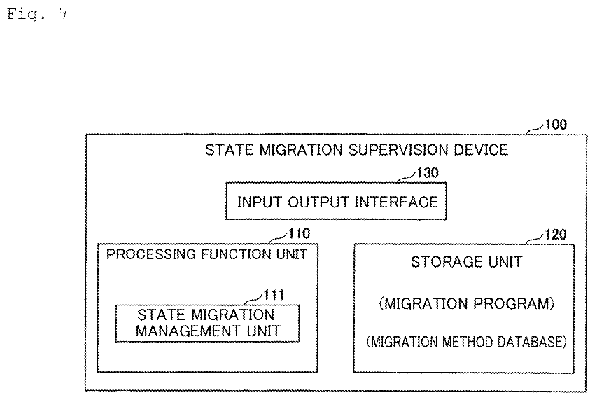

FIG. 7 shows a function configuration diagram of the state migration supervision device 100 according to the present embodiment. As shown in FIG. 7, the state migration supervision device 100 includes a processing function unit 110, a storage unit 120, and an input output interface 130. The processing function unit 110 includes a state migration management unit 111. The storage unit 120 stores a migration program, a migration method database, and the like. For example, the migration program is executed by the state migration supervision device 100 which is a computer to realize the processing function unit 110, and the processing function unit 110 may be operated according to the migration method recorded in the migration method database. The state migration management unit may be referred to as a migration management unit.

The state migration management unit 111, for example, receives, from a specific packet processing device, a notification indicating that processing of a packet of a specific flow is completed among packets of a plurality of flows stored in the storage unit of the packet processing device via the input output interface 130, and instructs another packet processing device to perform transfer processing of the state (the packet processing data) with the reception of the notification as a trigger.

Further, the state migration management unit 111, for example, determines the order of transferring the packet processing data in a plurality of packet processing devices so that the packet processing device for transferring the packet processing data does not exist in the progress direction of the packet of the flow other than a specific flow.

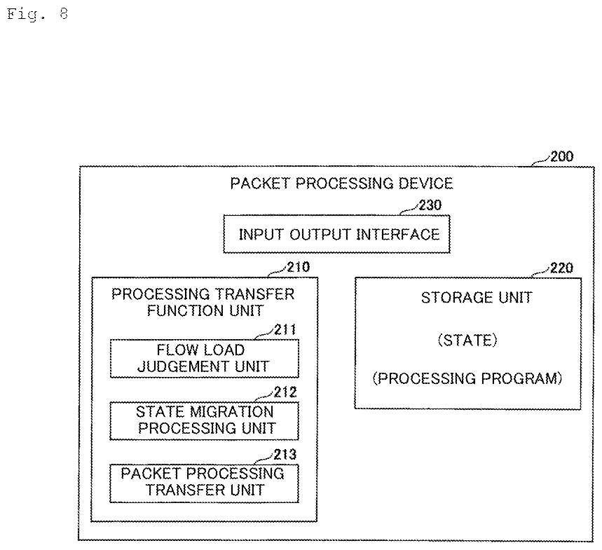

FIG. 8 shows a function configuration diagram of a packet processing device 200 according to the present embodiment. The packet processing device 200 can be used as any of the packet processing devices 201 to 203, and 221 to 223 shown in FIG. 6.

As shown in FIG. 8, the packet processing device 200 includes a processing transfer function unit 210, a storage unit 220, and an input output interface 230. The processing transfer function unit 210 includes a flow load judgement unit 211, a state migration processing unit 212, and a packet processing transfer unit 213. Note that the processing transfer function unit 210 may be referred to as “the network function”.

The input output interface 230 may be referred to as a transmission unit or a reception unit. The storage unit 220 stores a state, a processing program, and the like. For example, the processing transfer function unit 210 may be realized by executing the processing program by the packet processing device 200 which is a computer.

The storage unit 220 may include a queue function. That is, the storage unit 220 may store packets to be queued. The packet processing transfer unit 213 may include a queue function.

The flow load judgement unit 211 measures load information of each flow, and transmits the measured information to the state migration supervision device 100.

The state migration processing unit 212 includes a function of transmitting the state to the migration destination of the state, a function of receiving the state from the migration source of the state, and the like. The state migration processing unit 212 may be referred to as a packet processing data reception unit or a packet processing data transmission unit.

In addition, the state migration processing unit 212 has a function of notifying the state migration supervision device 100 that the processing of the packet of the specific flow is completed among the packets of the plurality of flows stored in the storage unit 220, and a function of starting the transmission of the state on the basis of the instruction from the state migration supervision device 100.

The packet processing transfer unit 213 includes a function of storing the arrived packet in the queue, reading the packet stored in the queue when the migration of the state is completed, processing the packet, and transferring the packet to the destination. The processing of the packet indicates, for example, processing of the packet on the firewall, processing of the packet on the IDS, and the like.

More specific operations of the state migration processing supervision device 100 and the packet processing device will be described later.

### Hardware Configuration Example

The state migration supervision device 100 and the packet transfer device 200 according to the present embodiment can be realized by causing a computer, for example, to execute a program in which the processing content explained in the present embodiment is described. Note that “the computer” may be a physical machine or a virtual machine in the cloud. When using the virtual machine, “the hardware” explained here is a virtual hardware.

The above mentioned program can be recorded on a computer-readable recording medium (a portable memory or the like) to be stored or be distributed. It is also possible to provide the program through the network such as the Internet or e-mail.

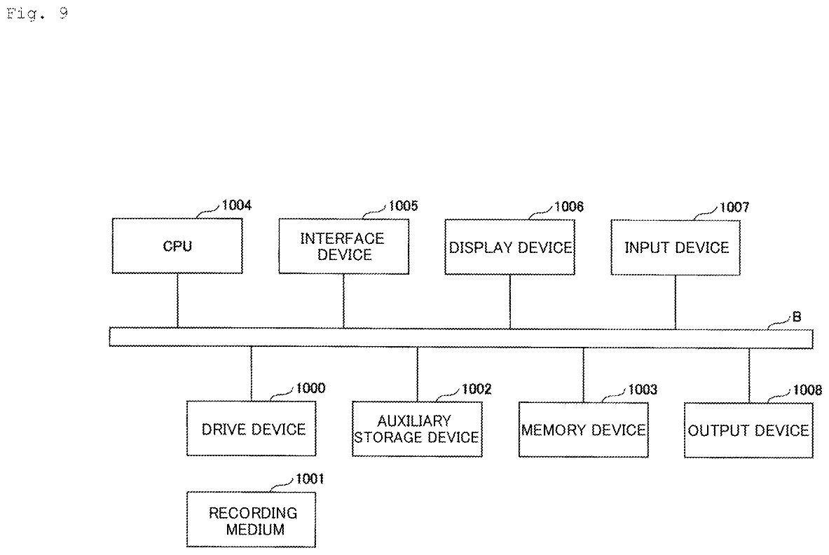

FIG. 9 is a diagram showing a hardware configuration example of the computer. The computer of FIG. 9 includes a drive device 1000, an auxiliary storage device 1002, a memory device 1003, a CPU 1004, an interface device 1005, a display device 1006, an input device 1007, and an output device 1008 connected to each other via a bus B.

The program for realizing processing in the computer is provided by, for example, a recording medium 1001 such as a CD-ROM or a memory card. When the recording medium 1001 having the program stored therein is set in the drive device 1000, the program is installed in the auxiliary storage device 1002 from the recording medium 1001 via the drive device 1000. However, the program does not necessarily have to be installed from the recording medium 1001, and may be downloaded from another computer via the network. The auxiliary storage device 1002 stores the installed program and also stores necessary files, data, and the like.

The memory device 1003 reads and stores the program from the auxiliary storage device 1002 when the start instruction of the program is received. The CPU 1004 realizes a function related to the device according to a program stored in the memory device 1003. The interface device 1005 is used as an interface for connecting to the network. The display device 1006 displays GUI (Graphical User Interface) and the like by the program. The input device 1007 is configured of a keyboard, a mouse, buttons, a touch panel, and the like, and is used for inputting various operation instructions. The output device 1008 outputs a calculation result. Note that the display device 1006, the input device 1007, and the output device 1008 may not be provided in the packet processing device 200.

### Operation Example of the Flow Migration

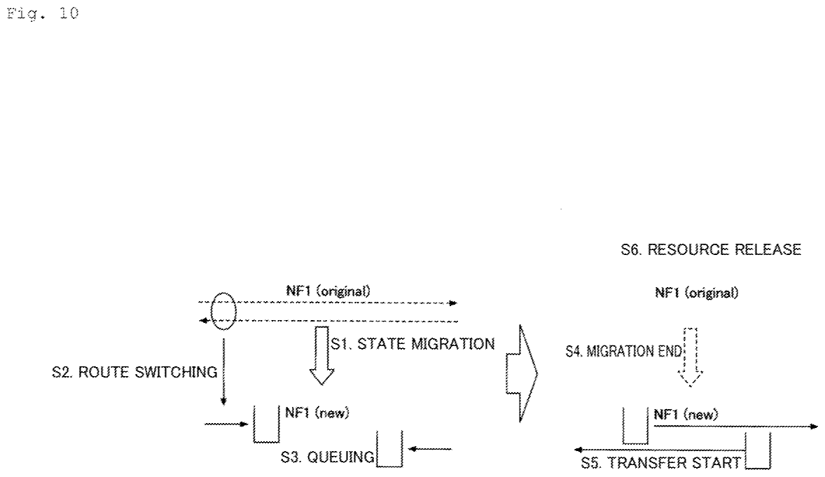

Before describing the flow migration when the flow passes through a plurality of NFs, the flow migration procedure when the flow passes through one NF will be described with reference to FIG. 10.

In S1, migration of a state from the NF1 (original) of a migration source to the NF1 (new) of a migration destination is started. In S2, the path of the flow is switched from a path passing through the NF1 (original) to a path passing through the NF1 (new).

In S3, the NF1 (new) stores (queues) packets arriving at the NF1 (new) in a queue. In S4, the migration of the state is completed. In 55, the NF1 (new) starts the transfer of the queued packet. In S6, the resource of the NF1 (original) is released.

### Overall Operation Example of System According to the Embodiment

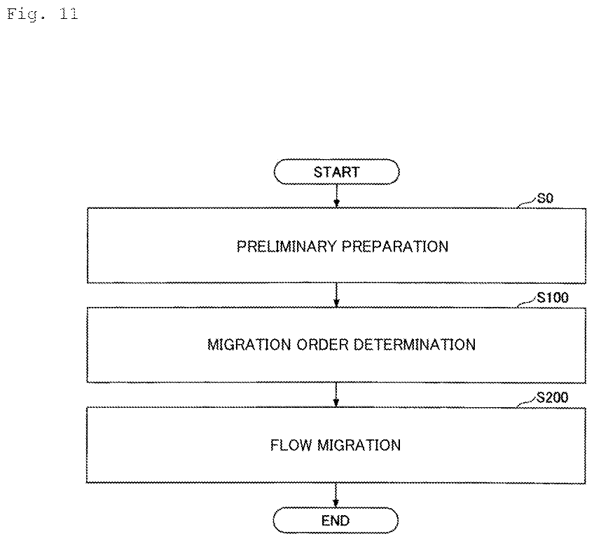

An overall operation of the system according to the present embodiment will be described with reference to FIG. 11. First, in 50, the state migration management unit 111 of the state migration supervision device 100 performs preliminary preparation.

When the migration of the flow of the transfer path occurs, the state migration management unit 111, in S100, uses information acquired from the preliminary preparation, in a plurality of NFs through which the flow passes, and determines in which order the state migration of the NF is to be performed.

In S200, the state migration supervision device 100 and the packet transfer device 200 execute the migration of the flow. A content of each step will be described below.

### (Preliminary Preparation)

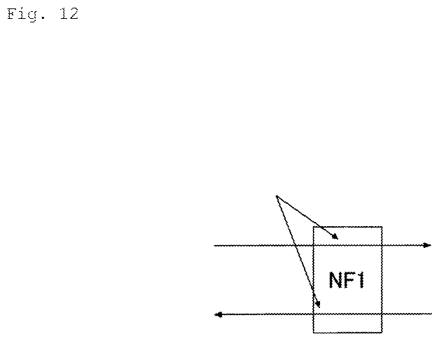

In the preliminary preparation, the flow load judgement unit 211 of the packet processing device 200 corresponding to the NF measures a traffic load and a packet processing time in the NF through which the bidirectional flow to be migrated passes. FIG. 12 shows an image of the measurement. The traffic load and the packet processing time measured for each NF are notified from the packet processing device 200 to the state migration supervision device 100.

More specifically, a flow arrival rate for each direction (the number of arrival packets per unit time for each direction), a packet processing time, and a packet transfer time are notified to the state migration supervision device 100.

The state migration management unit 111 of the state migration supervision device 100 estimates a time until a queue in each NF becomes empty for each direction of the flow on the basis of the flow arrival rate for each direction, the packet processing time and the packet transfer time measured for each NF. The time until the queue becomes empty is the time from the start of the transfer of packets stored in the queue until the end of the state transfer from the start of the state transfer until the queue becomes empty (the time until all packets are outputted from the queue).

The state migration management unit 111 calculates an estimated value of the time until the queue in each direction becomes empty according to the following Equation.

Estimated value=Flow arrival rate of each direction×Average packet stay time Equation (1)

The average packet stay time is calculated by the following Equation.

Average packet residence time=(sum of the processing time and the packet transfer time)/the number of packets arriving at the measurement time interval Equation (2)

The processing time and the packet transfer time are processing time and packet transfer time for all packets arriving in the measurement time interval.

With respect to the Equation (2), the packet stays in the NF (the packet processing device) only for the time required for processing the packet and the time required for transferring the packet, and the sum of these times is divided by the number of packets to obtain the average packet stay time per packet.

With respect to the Equation (1), by multiplying the rate (the number of packets per unit time) with the average packet stay time the time (the speed) until the queue becomes empty. It can be seen from the Equation (1), that the larger the rate and the larger the average packet stay time, the more the queue becomes empty.

### (Determination of the Migration Order)

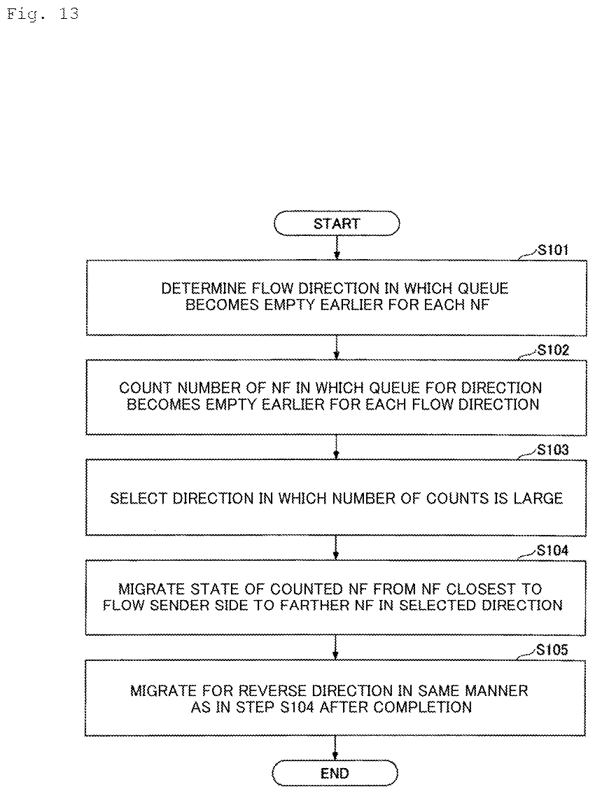

Next, referring to the flow charts of FIG. 13, a description will be given of the migration order determination processing executed by the state migration management unit 111. The flow chart of FIG. 13 also includes the state migration.

In S101, the state migration management unit 111 determines a direction of the flow in which the queue becomes empty earlier for each NF in a plurality of NFs through which the flow to be rearranged passes on the basis of the time until the queue becomes empty calculated in the preliminary preparation. Note that this result (the direction of the flow in which the queue becomes empty earlier) is notified to each NF of the state migration destination from the state migration management unit 111.

In S102, the state migration management unit 111 counts the number of NF in which the direction queue becomes empty earlier than the reverse direction queue for each flow direction. In S103, the state migration management unit 111 selects the direction having the larger count number.

In S104, the state migration management unit 111 instructs the NF (the packet processing device) to migrate the state of the counted NF from the NF closest to the sender side of the flow to the distant NF in the selected direction. After the processing in S104 is completed, the state migration management unit 111 executes the migration of the state in the reverse direction as in the step S104 in S105.

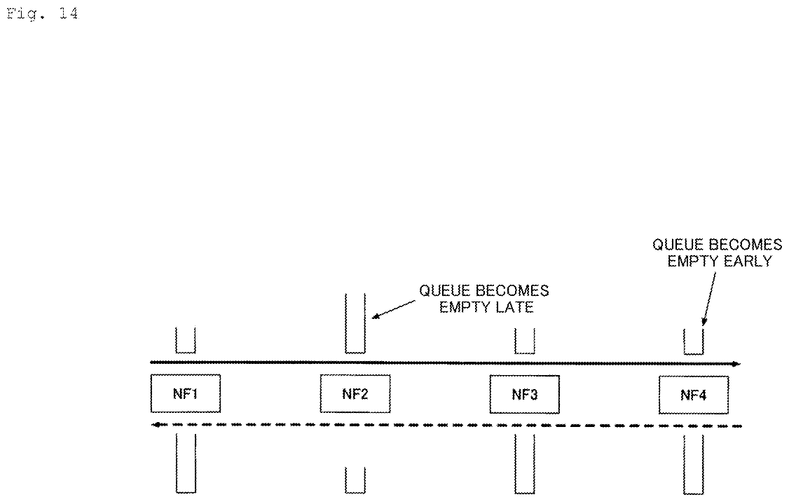

Referring to FIG. 14, a specific example of the migration order determination procedure described with reference to FIG. 13 will be described. FIG. 14 shows an example of a case in which the flow passes through the NF1 to NF4.

In S101 and S102, regarding a direction from the NF1 to the NF4, an NF in which the direction queue becomes empty earlier than a reverse direction queue is three of the NF1, NF3 and NF4, in the direction from the NF4 to the NF1, and the NF in which the direction queue becomes empty earlier than the reverse direction queue is one of the NF2.

In S103, since the flow in the direction from the NF1 to the NF4 has a larger count number than the flow in the direction from the NF4 to the NF1, the flow in the direction from the NF1 to the NF4 is selected.

In S104, state migration is performed in the order of NF1->NF3->NF4, and in S105, state migration of the NF2 is performed.

According to the above procedure, the order of state transfer in the plurality of NFs is determined so that no NF for transferring the state exists in the progress direction of packets of the flows other than the flow of the queue which becomes empty earlier. In the above example, since the state migration is performed at the NF4 after the state migration is completed at the NF3, for example, there is no NF for performing the state migration among NF existing in a path in a reverse direction to a flow of a queue going from the NF1 to the NF4 (a flow becoming empty earlier).

### (State Migration Procedure)

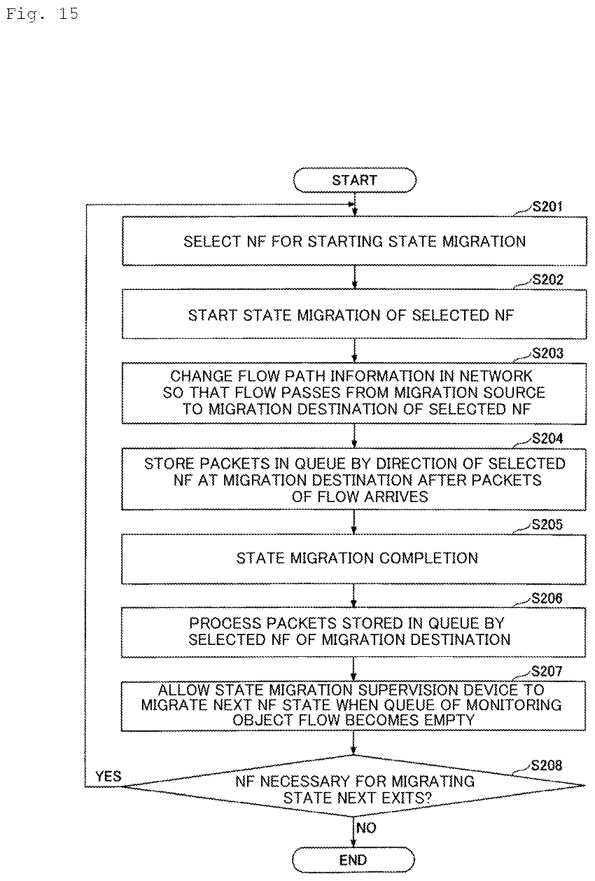

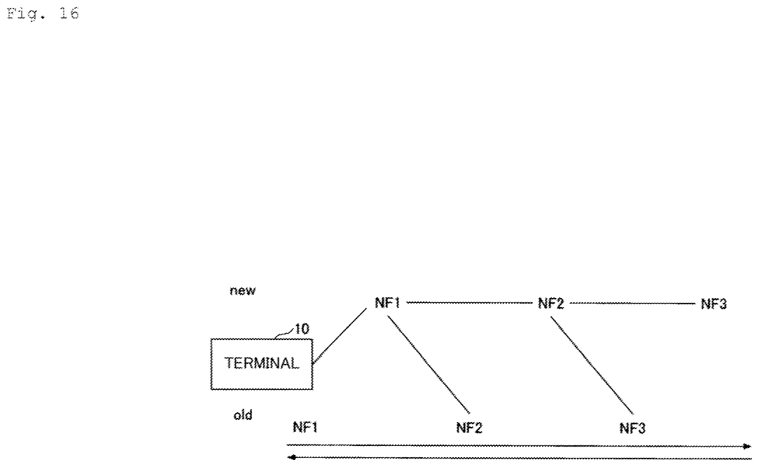

Next, an example of the state migration procedure in the flow rearrangement will be described with reference to the flowchart of FIG. 15. Here, the system configuration shown in FIG. 16 is assumed. As shown in FIG. 16, a path for transferring the flow is set in advance with respect to the NF of the flow rearrangement destination. That is, the path is set between the mobile terminal 10 and the NF1 (new), the path is set between the NF1 (new) and the NF2 (old), the path is set between the NF2 (new) and the NF3 (old), the path is set between the NF1 (new) and the NF2 (new), and the path is set between the NF2 (new) and the NF3 (new).

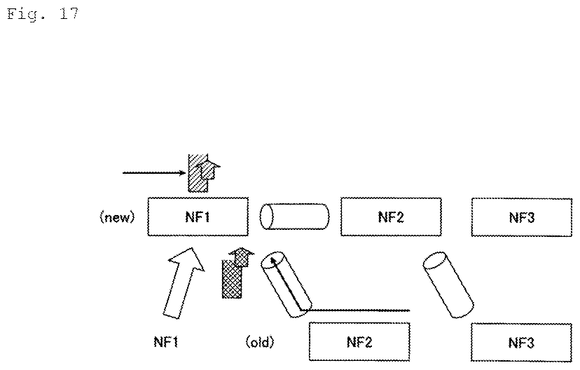

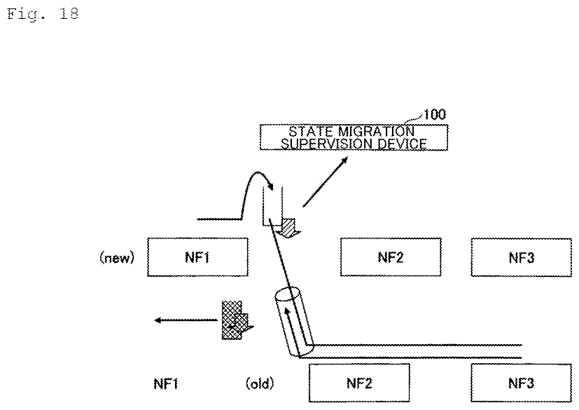

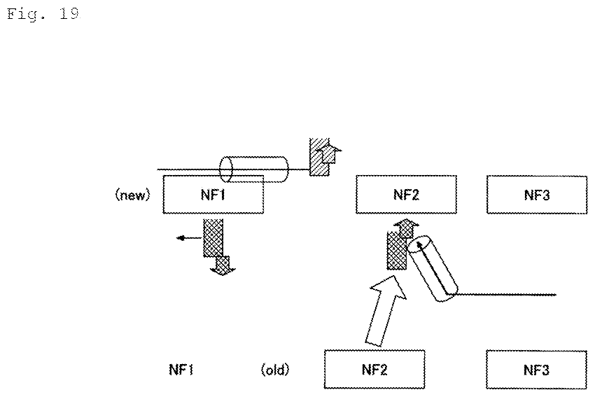

Hereinafter, the processing of state migration will be described in accordance with the procedure of FIG. 15. In description, FIGS. 17 to 18 indicating the specific example are also referenced appropriately.

In S201, the state migration management unit 111 of the state migration supervision device 100 selects the NF for starting the state migration, and instructs the NF to start the state migration. In S202, the state migration of the selected NF is started. More specifically, as shown in FIG. 17, the NF1 starts the state migration. For example, when the state migration management unit 111 instructs the state migration to the NF1 (old) and the NF1 (new), the state transfer from the NF1 (old) to the NF1 (new) is started.

In S203, the path information of the flow in the network is changed so that each flow passing through the NF of the migration source passes through the NF of the migration destination for the selected NF. The change of the path information may be executed by the state migration supervision device 100 or by other devices. More specifically, in FIG. 17, the path is changed so that the flow passing through the NF1 (old) passes the NF1 (new).

In S204, when packets of the flow arrive at the selected NF, the NF stores the packets in a queue by direction.

Specifically, as shown in FIG. 17, packets in the direction from the NF1 (new) to the NF2 (old) and packets in the direction from the NF2 (old) to the NF1 (new) are queued in the NF1 (new), respectively.

In S205, the selected NF detects completion of migration of the state of the NF. In S206, the selected NF processes the packets stored in the queue and transmits the packets.

In S207, the selected NF monitors the queue which becomes empty earlier as a monitoring object, and when the queue of the monitoring object flow becomes empty, and notifies the state migration supervision device 100 that the queue becomes empty. This notification corresponds to permitting the next NF state migration.

Specifically, in FIG. 18, when the state migration is completed in the NF1 which is the selected NF, the NF1 (new) processes the packets stored in each queue and transmits the packets. The NF1 (new) monitors the queue, as the monitoring object, storing the packets in the direction from the NF1 to the NF2 which is a queue to become empty earlier. When outputting all packets sored in the queue at the time of state migration completion, the NF1 (new) issues the state migration start permission for the next NF to the state migration supervision device 100.

In S208, the state migration management unit 111 determines whether or not the NF that needs to migrate the state next exists on the basis of the determination result of the migration order executed in S100, when the NF exist, returning to S201, selects the NF for starting state migration, and instructs the NF to migrate the state. Thereafter, processing of S202 to S208 is executed for the NF. Specifically, in FIG. 19, the state migration management unit Ill instructs the state migration to the NF2 (old) and the NF2 (new), and thereby starts the transfer of the state from the NF2 (old) to the NF2 (new).

### Effects of Embodiment

According to the technique described in the present embodiment, it is possible to suppress an increase in transfer delay during the flow rearrangement for packets directed in either direction in the rearrangement of the flow flowing through the network function.

### Conclusion of Embodiment

In the present specification, a transfer path change system, a packet processing device, a supervision device, a transfer path change method, and program which are at least described in each item are described.

### (Item 1)

A transfer path change system for changing a transfer path of a flow in a network, the transfer path change system includes a first packet processing device for processing and transferring a packet of the flow,
a second packet processing device installed in the transfer path after a change of the transfer path of the flow, and
a supervision device for supervising migration processing of packet processing data used by the first packet processing device to the second packet processing device, wherein
the second packet processing device includes
a packet processing data reception unit for receiving the packet processing data transferred from the first packet processing device,
a storage unit for storing a packet arriving at the second packet processing device during the transfer of the packet processing data, and
a packet processing transfer unit for processing the packets stored in the storage unit and transferring the packet to a destination, after the transfer of the packet processing data is completed, and
the supervision device includes
a migration management unit for instructing a third packet processing device, which performs transfer processing of the packet processing data next, to perform the transfer processing of the packet processing data with completion of the processing of a packet for a specific flow among packets of a plurality of flows stored in the storage unit in the second packet processing device as a trigger.

### (Item 2)

The transfer path change system according to item 1, wherein the specific flow is a flow having a shortest time until all stored packets are outputted from the storage unit among the plurality of flows.

### (Item 3)

A packet processing device installed in a transfer path after the transfer path of a flow in a network is changed, the packet processing device includes
a packet processing data reception unit for receiving packet processing data transferred from another packet processing device installed in the transfer path before the change,
a storage unit for storing a packet arriving at the packet processing device during the transfer of the packet processing data,
a packet processing transfer unit for processing the packet stored in the storage unit and transferring the packet to a destination,
after the transfer of the packet processing data is completed, and
a migration processing unit for notifying a supervision device that the processing of a packet of a specific flow is completed among packets of a plurality of flows stored in the storage unit.

### (Item 4)

A supervision device for supervising migration of packet processing data between a plurality of packet processing devices for processing and transferring a flow in a network, wherein a specific packet processing device installed in a transfer path after a change in the transfer path of the flow receives the packet processing data transferred from a packet processing device installed in the transfer path before the change, stores packets arriving at the specific packet processing device in a storage unit during the transfer of the packet processing data, and processes and transfers the packets stored in the storage unit after the transfer of the packet processing data is completed, and the supervision device includes a migration management unit for receiving a notification indicating completion of processing of a packet of a specific flow among the packets of a plurality of flows stored in the storage unit from the specific packet processing device, and
instructing another packet processing device to perform transfer processing of the packet processing data with the reception of the notification as a trigger.

### (Item 5)

The supervision device according to item 4, wherein the migration management unit determines an order of transferring the packet processing data in the plurality of packet processing devices so that there is no packet processing device for transferring the packet processing data in a progress direction of a packet of a flow other than the specific flow.

### (Item 6)

A transfer path change method in a transfer path change system for changing a transfer path of a flow in a network, wherein
the transfer path change system includes
a first packet processing device for processing and transferring a packet of the flow,
a second packet processing device installed in the transfer path after a change of the transfer path of the flow, and
a supervision device for supervising migration processing of packet processing data used by the first packet processing device to the second packet processing device, wherein
the second packet processing device
receives the packet processing data transferred from the first packet processing device,
stores a packet arriving at the second packet processing device during the transfer of the packet processing data in a storage unit, and
processes the packet stored in the storage unit and transfers the packet to a destination, after the transfer of the packet processing data is completed, and
the supervision device
instructs a third packet processing device, which performs transfer processing of the packet processing data next, to perform the transfer processing of the packet processing data with completion of the processing of a packet for a specific flow among packets of a plurality of flows stored in the storage unit in the second packet processing device as a trigger.

### (Item 7)

A program for causing a computer to function as each unit of the packet processing device according to item 3.

### (Item 8)

A program for causing a computer to function as each unit of the supervision device according to item 4 or 5.

The present embodiment has been described above, but the present invention is not limited to the specific embodiment. Various modifications and changes can be made within the scope of the gist of the present invention described in the claims.

### REFERENCE SIGNS LIST

10 Mobile terminal
11, 12 Task processing device
20 Base station
30 Edge cloud device
31 Virtual machine
100 State migration supervision device
110 Processing function unit
111 State migration management unit
120 Storage unit
130 Input output interface
200, 201 to 203, 221 to 223 Packet processing device
210 Processing transfer function unit
211 Flow load judgement unit
212 State migration processing unit
213 Packet processing transfer unit
220 Storage unit
230 Input output interface
1000 Drive device
1001 Recording medium
1002 Auxiliary storage device
1003 Memory device
1004 CPU
1005 Interface device
1006 Display device
1007 Input device
1008 Output device

1. A transfer path change system for changing a transfer path of a flow in a network, the transfer path change system comprising:
a first packet processing device configured to process and transfer a packet of the flow;
a second packet processing device installed in the transfer path after a change of the transfer path of the flow; and
a supervision device configured to supervise migration processing of packet processing data used by the first packet processing device to the second packet processing device, wherein
the second packet processing device comprises:
a first memory; and
a processor coupled to the first memory and configured to:
receive the packet processing data transferred from the first packet processing device;
store a packet arriving at the second packet processing device during the transfer of the packet processing data; and
process the packet stored and transfer the packet to a destination, after the transfer of the packet processing data is completed, and
the supervision device comprises:
a second memory; and
a processor coupled to the second memory and configured to:
instruct a third packet processing device, which performs transfer processing of the packet processing data next, to perform the transfer processing of the packet processing data with completion of the processing of a packet for a specific flow among packets of a plurality of flows stored in the second packet processing device as a trigger.

2. The transfer path change system according to claim 1, wherein
the specific flow is a flow having a shortest time until all stored packets are outputted among the plurality of flows.

3. A packet processing device installed in a transfer path after the transfer path of a flow in a network is changed, the packet processing device comprising:
a memory; and
a processor coupled to the memory and configured to:
receive packet processing data transferred from another packet processing device installed in the transfer path before the change,
store a packet arriving at the packet processing device during the transfer of the packet processing data,
process the packet stored and transfer the packet to a destination, after the transfer of the packet processing data is completed, and
notify a supervision device that the processing of a packet of a specific flow is completed among packets of a plurality of flows stored.

4. (canceled)

5. (canceled)

6. A transfer path change method in a transfer path change system for changing a transfer path of a flow in a network, wherein
the transfer path change system comprises:
a first packet processing device configured to process and transfer a packet of the flow;
a second packet processing device installed in the transfer path after a change of the transfer path of the flow; and
a supervision device configured to supervise migration processing of packet processing data used by the first packet processing device to the second packet processing device, wherein
the method comprises:
receiving, by the second packet processing device, the packet processing data transferred from the first packet processing device,
storing, by the second packet processing device, a packet arriving at the second packet processing device during the transfer of the packet processing data, and
processing, by the second packet processing device, the packet stored and transferring the packet to a destination, after the transfer of the packet processing data is completed, and
instructing, by the supervision device, a third packet processing device, which performs transfer processing of the packet processing data next, to perform the transfer processing of the packet processing data with completion of the processing of a packet for a specific flow among packets of a plurality of flows stored in the second packet processing device as a trigger.

7. A non-transitory computer-readable recording medium storing a program for causing a computer to function as the packet processing device according to claim 3.

8. (canceled)
